(19) United States
(12) Patent Application Publication
(10) Pub. No.: US 2025/0143257 A1
(43) Pub. Date: May 8, 2025

(54) Multifunctional Pet Bed

(71) Applicant: Jialong Zhou, Guangzhou (CN)

(72) Inventor: Jialong Zhou, Guangzhou (CN)

(21) Appl. No.: 19/019,236

(22) Filed: Jan. 13, 2025

(30) Foreign Application Priority Data
Jan. 25, 2024 (CN) 2024201843047

(51) Int. Cl. A01K 1/035

(52) U.S. Cl. CPC A01K 1/0353

(57) ABSTRACT

A multifunctional pet bed includes a pet bed body and a bottom mat. The pet bed body includes at least two tunnel bodies detachably connected from end to end to form an annular shape. The bottom mat is detachably arranged in the center of the annular shape pet bed body. An inner side of the tunnel body is provided with at least one first opening for pets to pass through, and an outer side of the tunnel body is provided with at least one second opening. Each tunnel body includes a cylindrical bag body supported by spiral elastic frameworks. The pet bed body formed by at least two tunnel bodies with openings provides pets with a comfortable space to sleep and play.

### CROSS-REFERENCE TO RELATED APPLICATIONS

The present application claims the benefit of Chinese Patent Application No. 2024201843047 filed on Jan. 25, 2024, the contents of which are hereby incorporated by reference.

### TECHNICAL FIELD

The present invention belongs to the technical field of pet supplies, and particularly relates to a multifunctional pet bed.

### TECHNICAL BACKGROUND

With the improvement of people's living condition, more and more people have pets. People's demand for pet supplies such as pet beds, is also gradually increasing. Most existing pet beds are cute but has relatively simple functions, just used for pets to rest. However, pets need activities and entertainment. And people's indoor living space is limited. Too many entertainment products for pet at home take up living space. Therefore, it is necessary to provide a pet bed with multiple functions.

### INVENTION CONTENT

In order to overcome at least one defect of the above-mentioned existing technology, the present invention provides a multifunctional pet bed, including a pet bed body and a bottom mat. The pet bed body is formed by at least two tunnel bodies with openings for pets to pass through. The multifunctional pet bed provides pets with a space for entertainment and sleeping without taking up additional space.

To achieve the above-mentioned purpose, the technical scheme adopted by the present invention is: a multifunctional pet bed, includes a pet bed body and a bottom mat arranged on the bed body. The bed body includes at least two tunnel bodies that are detachably connected from end to end, and at least two of the tunnel bodies together enclose to form a annular shape pet bed body; the bottom mat is detachably arranged in the center of the annular shape pet bed body. The inner side of the tunnel body is provided with at least one first opening for pets to pass through, and the outer side of the tunnel body is provided with at least one second opening.

The tunnel body includes a cylindrical bag body, and spiral elastic frameworks are arranged on the cylindrical bag body.

The cylindrical bag body includes a first fabric layer and a second fabric layer which are sequentially arranged from the outside to the inside. The first fabric layer and the second fabric layer are sewed together, and the elastic frameworks are arranged between the first fabric layer and the second fabric layer.

The two adjacent tunnel bodies are detachably connected by zippers, buttons or binding ropes; the bottom mat is detachably connected with the tunnel bodies by zippers, buttons or binding ropes.

The pet bed body is in a rectangular annular shape, and the bottom mat is in a rectangular shape.

Pet toys are hung on the first opening and/or the second opening.

Pet toys are hung on the first opening and/or the second opening by a connection rope.

The bottom mat includes a plush fabric layer, a silk cotton layer and a waterproof fabric layer which are sequentially sewn and fixed from the top to the bottom.

A plurality of anti-slip spots are arranged on the bottom side of the waterproof fabric layer away from the plush fabric layer.

After adopting the above technical scheme, the beneficial effects of the present invention are:
1. A multifunctional pet bed, includes a pet bed body and a bottom mat, and the pet bed body is formed by at least two tunnel bodies with openings for pets to pass through, to play, and to sleep inside or on the bottom mat; besides, users can make the said pet bed in different shape by using different number of the tunnel bodies; and pets can enjoy hiding and concealing games inside the tunnel bodies.
2. The tunnel body includes a cylindrical bag body and spiral elastic frameworks; it is convenient for the users to disassemble and fold the pet bed for storage.
3. Both the inner and outer sides of the tunnel body are provided with openings for pets to enter inside to rest on the bottom mat without jumping in and out.
4. Pet toys are hung on the openings for pets to play;
5. The pet bed body is in rectangular shape but not limited to rectangular annular shape. The bottom mat is in rectangular shape but not limited to rectangular shape. The rectangular shape pet bed design is more in line with the pets' sleeping postures. Pets can stretch comfortably in the said multifunctional pet bed.

### DESCRIPTION OF FIGURES

In order to more clearly illustrate the embodiments of the present invention or the technical schemes of the existing technology, the drawings required for use in the embodiments or the description of the existing technology are briefly introduced below. Obviously, the drawings described below are only some embodiments of the present invention. For ordinary technicians in this field, other drawings can be obtained based on these drawings without paying creative work.

FIG. 1 is a schematic view of the structure of the present invention;

FIG. 2 is a bottom view of the schematic view of the structure of the present invention;

FIG. 3 is a side view corresponding to FIG. 1;

FIG. 4 is a schematic view of the structure of a bottom mat of the present invention;

FIG. 5 is a schematic view of the folding effect of the present invention.

FIG. 6 is a schematic view of another structural scheme of the present invention;

FIG. 7 is a schematic view of another structural scheme of the present invention.

### DESCRIPTION OF MARKS IN FIGURES

pet bed body; 2—bottom mat; 11—tunnel body; A-first opening; B-second opening; 111—elastic framework; 112—first fabric layer; 113—second fabric layer; 3—button; 4—elastic rope loop; 5—zipper; 6—toy; 7—connection rope; 21—waterproof fabric layer; 22—anti-slip spot.

### DETAILED DESCRIPTION OF THE EMBODIMENTS

Below is a further detailed description of the present invention based on the figures.

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

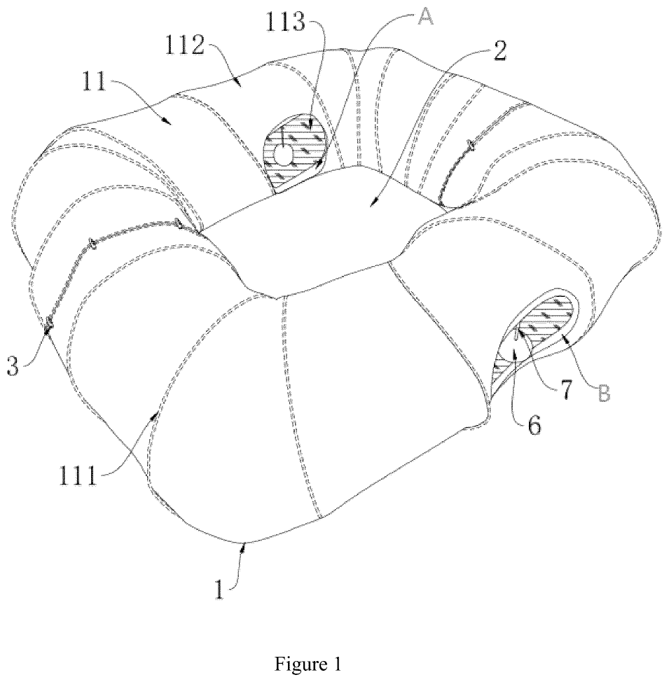

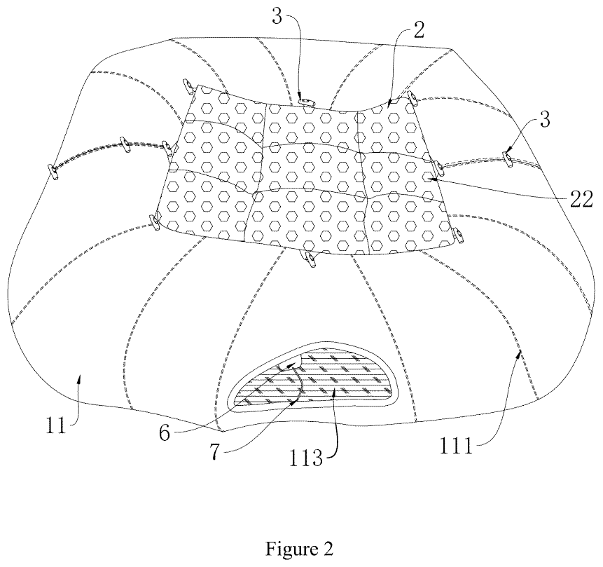

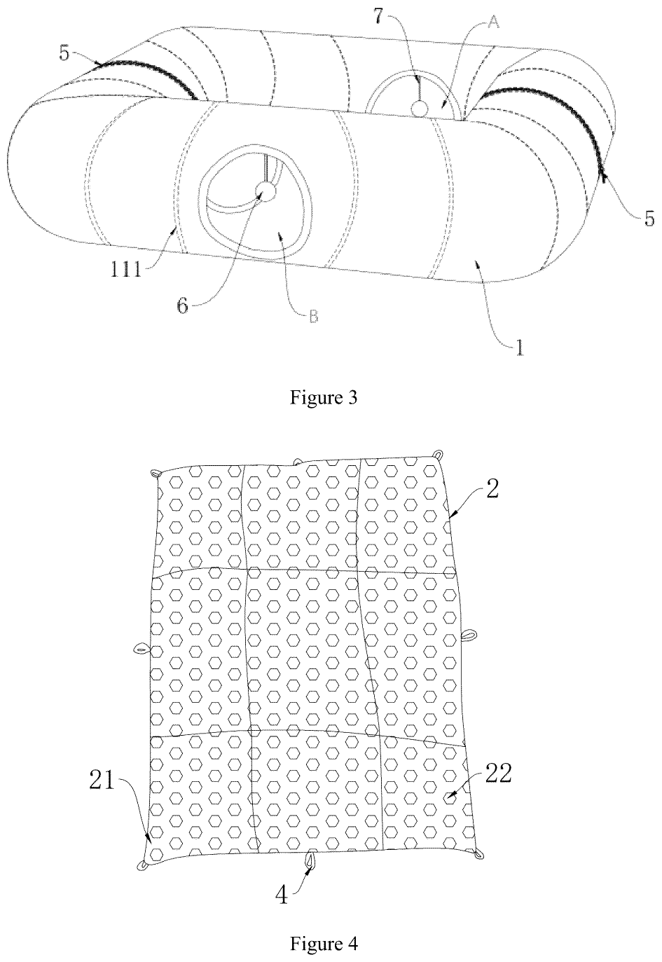

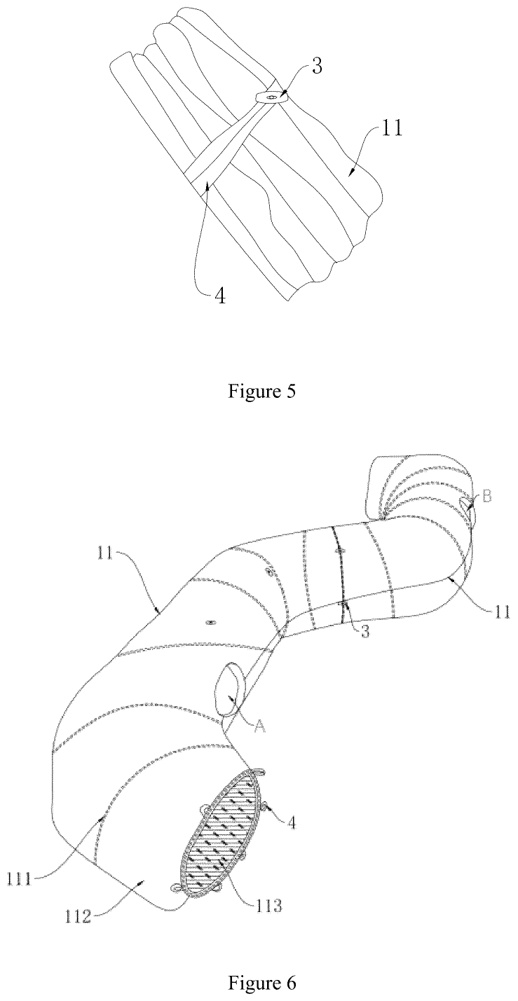

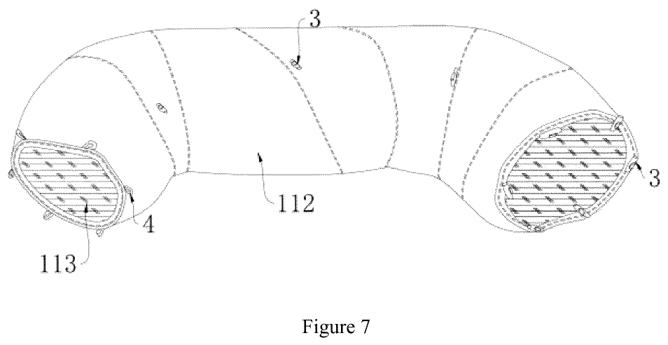

As shown in FIGS. 1 to 7, a multifunctional pet bed, includes a pet bed body 1 and a bottom mat 2. The bottom mat 2 is used for pets such as pet cats or pet dogs to rest. The pet bed body 1 includes at least two tunnel bodies 11. The tunnel body 11 is used for pets to pass through, hide, and play. At least two tunnel bodies 11 are detachably connected from end to end to enclose and form a annular shape pet bed body. The bottom mat 2 is detachably arranged in the center of the annular shape pet bed body 1. At least one first opening A for pets to pass through is arranged on the inner side of the tunnel body 11, and at least one second opening B is arranged on the outer side of the tunnel body 11.

The pet bed body 1 is composed of two tunnel bodies 11 enclosed together, and a first opening A and a second opening B are respectively arranged on the inner side and the outer side of the pet bed body 1. Pets can crawl in and out of the tunnel bodies 11, and walk or play in the tunnel bodies 11. At the same time, pets can enter the tunnel bodies 11 from the second opening B and then exit from the first opening A to rest on the bottom mat 2 in the center without jumping. The two adjacent tunnel bodies 11 are detachably connected, and the tunnel bodies 11 and the bottom mat 2 are detachably connected. Users can use a different number of tunnel bodies to form different shapes of a pet bed based on their needs.

Optionally, the bottom mat 2 includes a mat cover and a mat core, and the mat core is arranged inside the mat cover. The bottom mat 2 is made of a plush fabric layer but not limited to a plush fabric layer, a silk floss layer and a waterproof fabric layer 21 that are sewn and fixed from the top to the bottom in sequence, and a soft and resilient silk floss layer is filled between the plush fabric layer and the waterproof fabric layer 21. The plush fabric layer and the waterproof fabric layer 21 are sewn into a mat cover which can provide a good sleeping environment for pets. In winter, the upper fabric of the bottom mat is a plush fabric layer, so that pets sleep comfortably and warmly on the plush fabric layer. In summer, the upper fabric of the bottom mat is a rattan mat, a technological cloth, polyester, an Oxford cloth, etc., so that pets sleep more comfortably, breathably and coolly. Optionally, the silk floss layer of the bottom mat can be taken out, which is easy to disassemble and wash. In this embodiment, a plurality of anti-slip spots 22 are arranged on the side of the waterproof fabric layer 21 away from the plush fabric layer. The setting of the anti-slip spots 22 allows the pet bed to be stably placed on the ground, reducing the pet bed from sliding on the ground.

Optionally, as shown in FIGS. 1 to 4, 6 to 7, in order to facilitate the folding and storage of the pet bed, each tunnel body 11 includes a cylindrical bag body and an elastic framework 111, which is arranged in a spiral shape on the cylindrical bag body. The elastic framework 111 is fixed in the cylindrical bag body by sewing to support the cylindrical bag body, so that pets can pass through, so as to support the bag body to be unfolded and conveniently folded and stored.

Further, as shown in FIGS. 1 to 4, the cylindrical bag body includes a first fabric layer 112 and a second fabric layer 113 arranged sequentially from the outside to the inside. The first fabric layer 112 and the second fabric layer 113 are sewed together, and the elastic frameworks 111 are arranged between the first fabric layer 112 and the second fabric layer 113. The first fabric layer 112 can be a fluffy fabric or a non-fluffy fabric. The fluffy fabric can be a long-fluffy fabric, a granular fluffy fabric or a short-fluffy fabric to meet the need for warmth in winter. The non-fluffy fabric can be a cool fabric or an Oxford cloth fabric, which is suitable for the need for coolness in summer.

Optionally, as shown in FIGS. 1 to 7, in order to disassemble and splice the pet bed body 1, the two adjacent tunnel bodies 11 are detachably connected by zippers 5 or buttons 3 or binding ropes. The bottom mat 2 is detachably connected with the tunnel bodies by zippers 5 or buttons 3 or binding ropes. In one embodiment, a plurality of elastic rope loops 4 are fixed at intervals on the opening edge of one end of the tunnel body 11, and a plurality of buttons 3 that can be buckled with the elastic rope loops 4 are arranged at intervals on the opening edge of another end of the tunnel body 11. In one embodiment, opposite chains are fixedly arranged at the opening edges at two ends of the tunnel bodies 11, and a zipper 5 head that is plugged with the other chain is arranged on one chain. A plurality of buttons 3 are arranged on a side of the tunnel body 11 close to the bottom mat 2, and elastic rope loops 4 that can be snapped with the buttons 3 on the side wall of the tunnel body 11 are arranged on the edge of the bottom mat 2.

Optionally, the pet bed body 1 is in rectangular annular shape but not limited to a rectangular annular shape, and the bottom mat 2 is in rectangular shape but not limited to a rectangular shape. The rectangular shape pet bed design is more in line with the pets' sleeping postures, and pets can stretch comfortably in the pet bed. Optionally, the tunnel body 11 can be in an arc shape, a [symbol] shape, a ] shape, or a (shape.

Optionally, to increase the entertainment value of the pet bed, pet toys 6 are hung on the first opening A and/or the second opening B. The pet toys 6 can be feathers, wool balls, or fur balls.

Further, the pet toys 6 are hung on the first opening A and/or the second opening B through a connection rope 7. Two ends of the connection rope 7 are respectively sewed and fixed to the pet toys 6 and the cylindrical bag body.

The above is only used to illustrate the technical solution of the present invention rather than to limit the present invention. Other modifications or equivalent substitutions made to the technical solution of the present invention by ordinary technicians in this field should be included in the scope of the claims of the present invention as long as they do not depart from the spirit and scope of the technical solution of the present invention.

What is claimed is:

1. A multifunctional pet bed, comprises a pet bed body and a bottom mat, wherein the pet bed body comprises at least two tunnel bodies detachably connected from end to end so as to enclose and form an annular bed body; the bottom mat is detachably arranged in the center of the annular pet bed body; an inner side of the tunnel body is provided with at least one first opening for pets to pass through, and an outer side of the tunnel body is provided with at least one second opening.

2. The multifunctional pet bed according to claim 1, wherein the tunnel body comprise a cylindrical bag bodies; and spiral elastic frameworks are arranged inside the cylindrical bag body to support the bag body forming an inner space.

3. The multifunctional pet bed according to claim 2, wherein the cylindrical bag body comprises a first fabric layer and a second fabric layer arranged sequentially from outside to inside; the first fabric layer and the second fabric layer are sewed together, and the elastic frameworks are arranged between the first fabric layer and the second fabric layer.

4. The multifunctional pet bed according to claim 1, wherein two adjacent tunnel bodies are detachably connected by zippers, buttons or binding ropes; and the bottom mat is detachably connected with the tunnel body by zippers, buttons or binding ropes.

5. The multifunctional pet bed according to claim 1, wherein the pet bed body is in a rectangular annular shape and the bottom mat is in a rectangular shape.

6. The multifunctional pet bed according to claim 1, wherein pet toys are hung on the first opening and/or the second opening.

7. The multifunctional pet bed according to claim 6, wherein pet toys are hung on the first opening and/or the second opening by a connection rope.

8. The multifunctional pet bed according to claim 1, wherein the bottom mat from top to bottom are sewn with a plush fabric layer, a silk cotton layer and a waterproof fabric layer.

9. The multifunctional pet bed according to claim 8, wherein a plurality of anti-slip spots are arranged on a bottom side of the waterproof fabric layer away from the plush fabric layer.
